(19) United States
(12) Patent Application Publication
(10) Pub. No.: US 2011/0235096 A1
(43) Pub. Date: Sep. 29, 2011

(54) PRINT JOB DATA MANAGEMENT DEVICE, PRINTING APPARATUS, PRINT JOB DATA MANAGEMENT METHOD AND PRINT JOB DATA MANAGEMENT PROGRAM STORAGE MEDIUM

(75) Inventor: Masayuki Iwasawa, Kanagawa (JP)

(73) Assignee: FUJI XEROX CO., LTD., Tokyo (JP)

(21) Appl. No.: 12/873,398

(22) Filed: Sep. 1, 2010

(30) Foreign Application Priority Data
Mar. 25, 2010 (JP) 2010-070466

(51) Int. Cl. G06F 3/12

(52) U.S. Cl. 358/1.15

(57) ABSTRACT

A print job data management device includes a storage section that stores a print job, a reception section that receives a print job transmitted by a sender, a print execution section, and an extraction section. The print execution section executes printing immediately when the received print job is a first print job without authentication data attached thereto, and, when the print job is a second print job with authentication data attached thereto, temporarily stores the second print job in the storage section and executes printing in response to an authentication of a recipient of a printout. The extraction section extracts the second print job for which a specific duration has elapsed from the storing in the storage section. The print job data management device deletes the print job when the sender and the recipient of the second print job extracted by the extraction section are the same.

### CROSS-REFERENCE TO RELATED APPLICATION

This application is based on and claims priority under 35 USC 119 from Japanese Patent Application No. 2010-070466 filed on Mar. 25, 2010.

### BACKGROUND

1. Technical Field

The present invention relates to a print job data (information) management device, a printing apparatus, a print job data management method, and a print job data management program storage medium.

2. Related Art

An image forming apparatus is proposed in which, when performing confidential printing, receives printing data for printing, and job data including data that indicates whether or not the printing data is requested to be printed in confidential printing, and data that associates the job data with the print data. The received print data is controlled according to the job data.

### SUMMARY

An aspect of the present invention is a print job data management device including: a storage section that stores a print job; a reception section that receives a print job transmitted by a sender; a print execution section that executes printing immediately when the print job received by the reception section is a first print job without authentication data attached thereto, and, when the print job is a second print job with authentication data attached thereto, temporarily stores the second print job in the storage section and executes printing in response to an authentication of a recipient of a printout; and an extraction section that extracts the second print job for which a specific duration has elapsed from the storing of the second print job in the storage section, wherein the print job data management device deletes the print job when the sender and the recipient of the second print job extracted by the extraction section are the same.

### BRIEF DESCRIPTION OF THE DRAWINGS

Exemplary embodiments of the present invention will be described in detail based on the following figures, wherein:

FIG. 1 is a schematic diagram of a printing system according to the present exemplary embodiment;

FIG. 2 is a block diagram showing a hardware configuration of a print server according to the present exemplary embodiment;

FIG. 3 is a functional block diagram based on processing executed by a CPU of a print server of the present exemplary embodiment;

FIG. 4 is a security determination condition table employed in determination processing in a determination section;

FIG. 5 is a user list table employed when an authentication request attaching section attaches an authentication request to a print job;

FIG. 6 is a block diagram showing a hardware configuration of an image forming apparatus according to the present exemplary embodiment;

FIG. 7 is a functional block diagram based on processing executed by a CPU of the image forming apparatus according to the present exemplary embodiment;

FIG. 8 is a group confidential box table according to the present exemplary embodiment;

FIG. 9 is diagram of confidential boxes set in an image forming apparatus according to the present exemplary embodiment;

FIG. 10 is a flow chart showing an operation of a print server in a printing system according to the present exemplary embodiment;

FIG. 11 is an example of recording paper printed in a printing system according to the present exemplary embodiment;

FIG. 12 is a flow diagram showing a process from extracting data from a banner sheet to a generation of a data extraction table according to the present exemplary embodiment;

FIG. 13 is a flow diagram showing a process from data extraction from a ledger page to a generation of a data extraction table according to the present exemplary embodiment;

FIG. 14 is a flow chart for explaining details of the authentication setting processing shown at step 105 in FIG. 10, according to the present exemplary embodiment;

FIG. 15 is a flow chart for explaining an operation of the image forming apparatus that has received a print job, according to the present exemplary embodiment;

FIG. 16 is a flow chart showing a management control processing of print jobs stored in a print job storage section of the image forming apparatus according to the present exemplary embodiment; and

FIG. 17 is a flow chart showing a control processing for notifying print processing completion by the image forming apparatus, according to the present exemplary embodiment.

### DETAILED DESCRIPTION

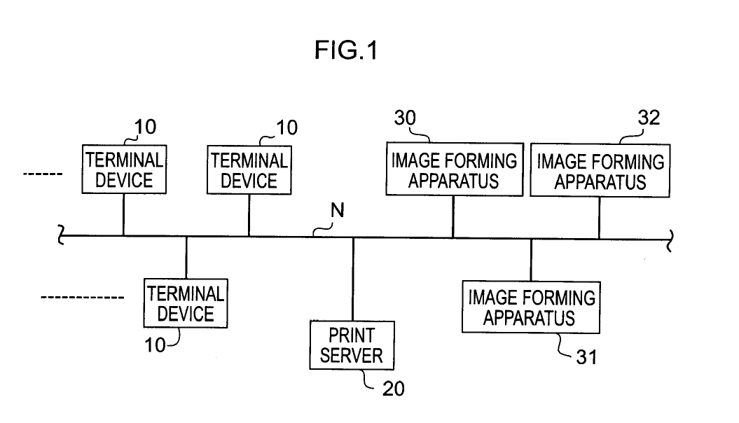

A printing system according to the present exemplary embodiment is shown in FIG. 1. A terminal device 10 generates a print job, and transmits the generated print job to a print server 20 via a communications network N.

Here, “print job” refers to, for example, data expressed in a page description language in a format interpretable by an image forming apparatus, and is data that can be interpreted and converted into bit map data by the image forming apparatus.

The print server 20 functions as a print control apparatus and transmits the received print job to one of image forming apparatuses 30 to 32. Alternately, the print server 20 may transmit the print job to plural image forming apparatus among the image forming apparatuses 30 to 32. The print job transmitted from the print server 20 is received by one or more of the image forming apparatuses 30 to 32, and an image is output onto a printing paper based on the received print job.

Print Server 20

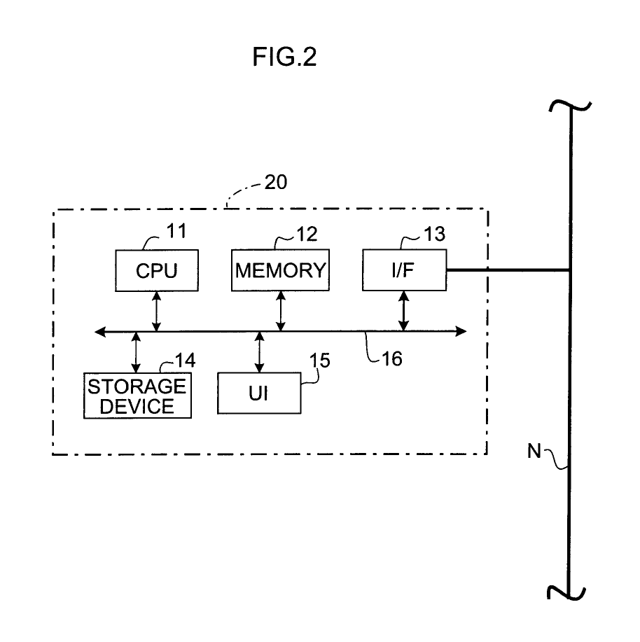

As shown in FIG. 2, the print server 20 includes a CPU 11, a memory 12, a communications interface (I/F) 13 that transmits and receives data with, for example, external devices and the like, a storage device 14 such as a Hard Disk Drive (HDD), and a user interface (UI) 15 including a touch panel, a liquid crystal display and/or a keyboard. These components are mutually connected together through a control bus 16.

The CPU 11 executes specific processing based on a control program which is stored in the memory 12 or the storage device 14, and controls the operation of the print server 20. In the present exemplary embodiment, an example in which the CPU 11 reads out and executes a control program stored in the memory 12 or the storage device 14 is described. However, the present exemplary embodiment is not limited thereto, and it is possible for the program to be stored on a storage medium, such as a CD-ROM, and may be supplied to the CPU 11 therefrom.

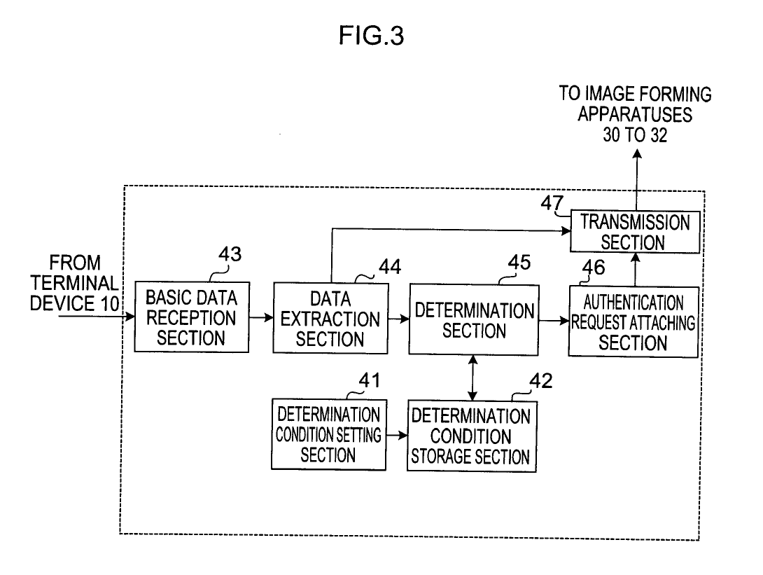

Data which is to be a base of printing (basic data) is received from the terminal device 10 by the print server 20, a print job is generated based on authentication necessity and attributions of the image forming apparatus connected on the communications network N and the like. The print job is then stored and transmitted to the image forming apparatuses 30 to 32. FIG. 3 is a block diagram showing a functional configuration executed mainly with the CPU 11, from generation of the print job to the transmission thereof.

As shown in FIG. 3, a determination condition setting section 41 sets a security determination condition for determining whether or not a print job requires authentication when performing print processing based on the received print job (print instruction).

For example, the determination condition setting section 41 sets, as a security determination condition, whether or not one or a combination of two or more set of data including the print job name (print instruction name), title (subject), print destination, user name and customer name match preset data. A determination condition storage section 42 stores the security determination conditions (a table thereof) set by the determination condition setting section 41.

A basic data reception section 43 receives the basic data transmitted from the terminal device 10. Here, “basic data” refers to text data for generating a print job, and may be transmitted from the plural terminal devices 10 in a divided manner or successively in a time series, and these sets of data are aggregated at the print server 20 and a print job is generated therefrom.

A data extraction section 44 extracts preset specific data from the basic data received by the basic data reception section 43.

A determination section 45 determines whether or not the basic data received by the basic data reception section 43 matches the security determination condition set by the determination condition setting section 41. Specifically, the determination section 45 determines whether or not the data extracted by the data extraction section 44 matches the security determination condition set by the determination condition setting section 41.

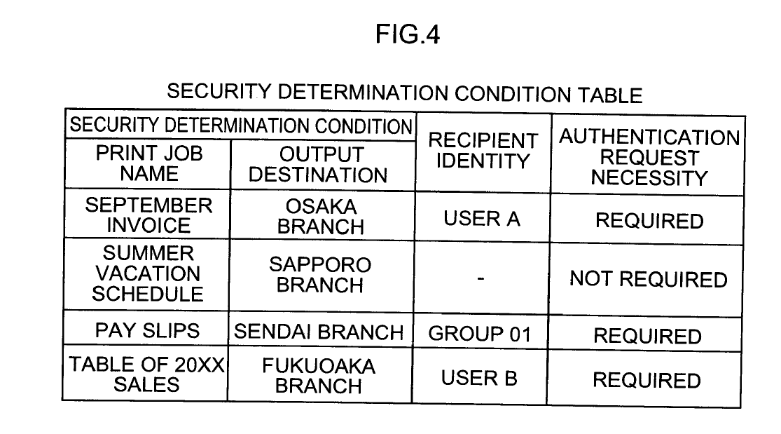

A security determination condition table, as shown in FIG. 4, is employed as the security determination condition when the determination section 45 performs determination processing.

In the security determination condition table shown in FIG. 4, the condition of the print job name and the output destination are set as the security determination condition. For example, a condition is set such that a determination is made that an authentication request is required for print jobs set with a print job name of “September Invoice” and output destination of “Osaka Branch”. Further, a setting is made such that “User A” is specified as the recipient for such a print job.

As shown in FIG. 3, when a determination is made in the determination section 45 as to the print job received by the basic data reception section 43 matches the security determination condition, an authentication request attaching section 46 attaches an authentication request to the print job. In the case in which such an authentication request has been attached, the print job will not be immediately printed to a paper, and instead, printing of the print job to a paper is performed after an authentication, such as user authentication, has been preformed. In other words, a print job to which an authentication request has been attached is treated as a print job for confidential printing. The authentication request is an example of data expressing that the print job requires authentication when performing print processing based on the print job.

Specifically, the authentication request attaching section 46 attaches an authentication request by setting a recipient and a password for a print job transmitted by a transmission section 47.

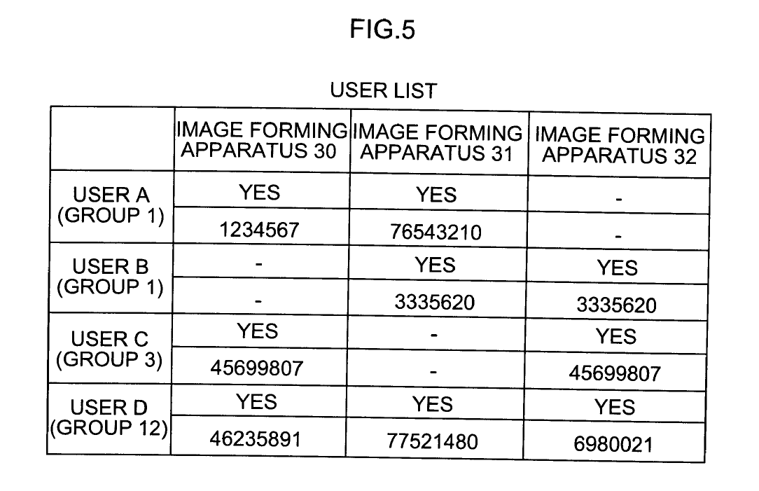

An example of a user list employed when the authentication request attaching section 46 attaches an authentication request to a print job is shown in FIG. 5. The user list may be stored in the memory 12 or the storage device 14.

For example, when the determination section 45 determines that “User A” is specified as the recipient, the authentication request attaching section 46, based on a user list as shown in FIG. 5, sets “1234567” as the password if the output destination is the image forming apparatus 30, and sets “76543210” as the password if the output destination is the image forming apparatus 31. When a group is specified as the recipient, the authentication request attaching section 46 merely sets the print job with the fact that authentication request is required and the recipient.

The transmission section 47 transmits the print job, received by the basic data reception section 43 and attached with the authentication request by the authentication request attaching section 46, to at least one of the image forming apparatuses 30 to 32.

Image Forming Apparatuses 30 to 32

Since the fundamentally control configuration of each of the image forming apparatuses 30 to 32 is the same, the following explanation describes a configuration of the image forming apparatus 30 as a representative.

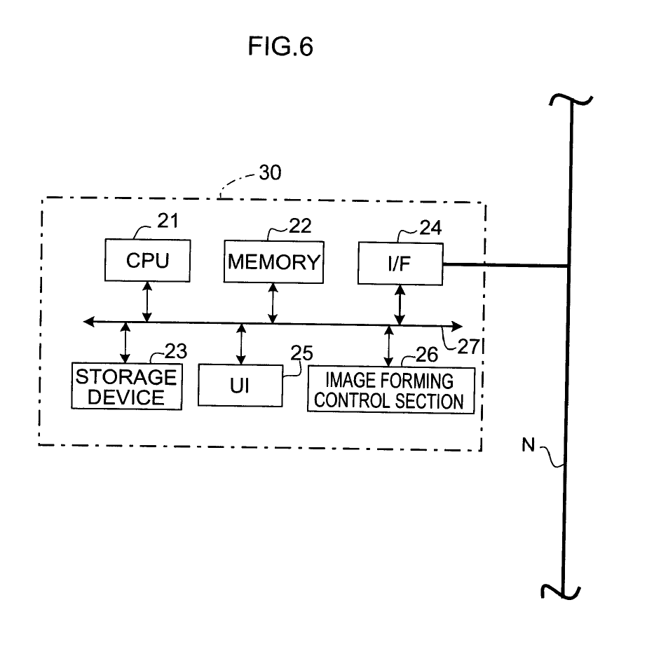

As shown in FIG. 6, the image forming apparatus 30 includes a CPU 21, a memory 22, a storage device 23 such as a Hard Disk Drive (HDD), an interface (I/F) 24 that performs transmission and reception of data between external devices and the like, via the communications network N, a user interface (U/I) 25 including a touch panel, or a liquid crystal display and a keyboard, and an image forming control section 26. These configuration elements are mutually connected together through a control bus 27.

The CPU 21 executes specific processing based on a control program stored in the memory 22 or the storage device 23, and controls the operation of the image forming apparatus 30. In the present exemplary embodiment, explanation is given in a case in which the CPU 21 reads out and executes the control program stored in the memory 22 or the storage device 23. However, exemplary embodiments are not limited thereto, and it is possible to store such a program on a storage medium such as a CD-ROM, and supply the program to the CPU 21 therefrom.

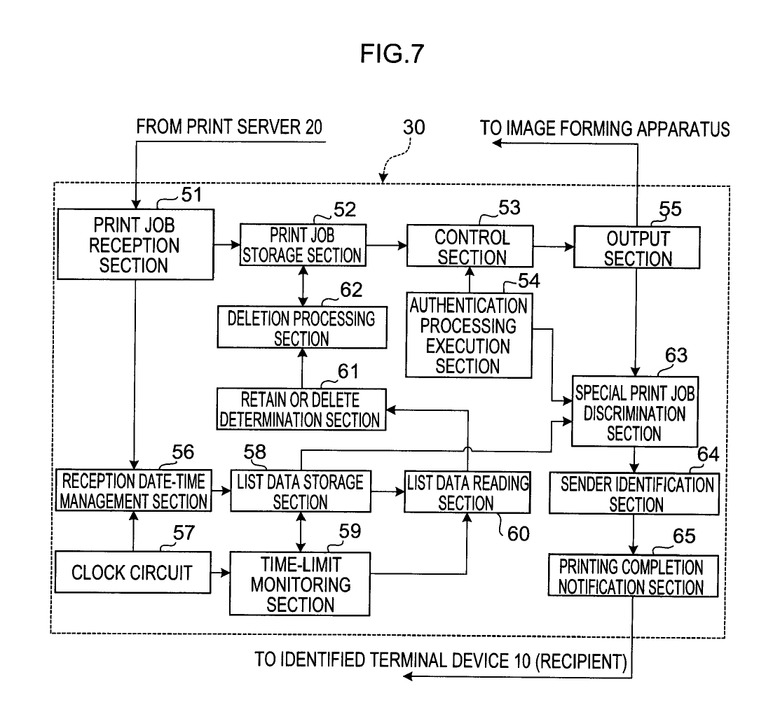

In the image forming apparatus 30, in response to a reception of a print job, an image is formed on a recording paper. FIG. 7 is a block diagram showing a functional configuration of image forming processing, based on the print job and mainly executed by the CPU 21.

As shown in FIG. 7, a print job reception section 51 receives a print job that has been transmitted from the print server 20. A print job storage section 52 stores the print job received by the print job reception section 51.

An output section 55 outputs an image under control of the control section 53, and based on the print job received by the print job reception section 51 and stored in the print job storage section 52. The control section 53 controls image output processing in the output section 55.

When an authentication request is attached to the print job on which image output processing is to be performed, an authentication processing execution section 54 executes authentication processing prior to the print job being executed in the output section 55. The authentication processing executed by the authentication processing execution section 54 may be authentication processing to get a password input by keyboard input or the like, or may be authentication processing employing an IC card or the like. The authentication processing may also, for example, utilize a method based on biometric data, employing finger prints, vein patterns, iris patterns, or the like.

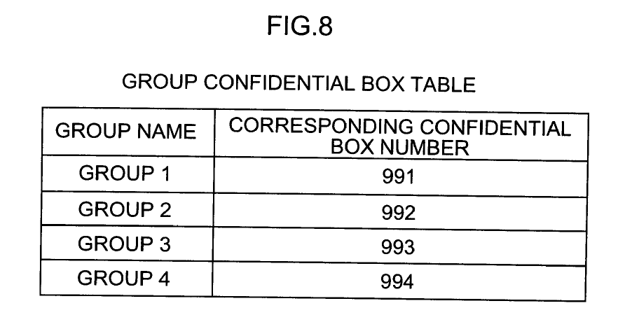

When an authentication request having a group specified as the recipient is attached to the print job for performing image output processing, a confidential box is specified for storage based on a group confidential box table as shown in FIG. 8, and the print job is stored in this confidential box. The group confidential box table may, for example, be stored in the memory 22 or the storage device 23.

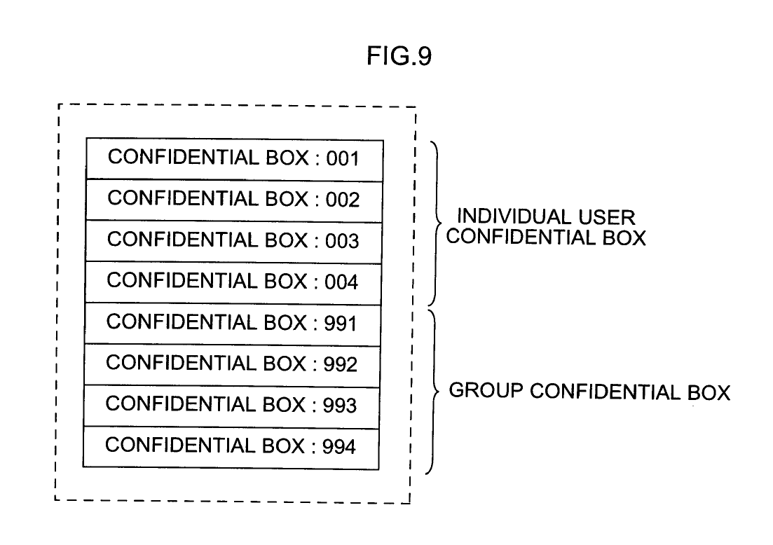

An example of a confidential box set in the image forming apparatus is shown in FIG. 9. In the example shown in FIG. 9, the confidential boxes “001” to “004” are set for storing the print job with an individual user as the recipient, and the confidential boxes “991” to “994” are set for storing the print job with a group as the recipient.

For example, a print job having an authentication request with group 1 specified as the recipient will be stored in confidential box number “991”. In order to execute the print job stored in the confidential box number “991”, authentication processing of inputting a preset password is required.

Print Job Management Control in Image Forming Apparatus

In the present exemplary embodiment, since print processing is executed successively in the image forming apparatuses 30 to 32 unless an authentication request is attached to one of the print jobs, for such print jobs, the period of time stored in the print job storage section 52 is relatively short. However, when an authentication request is attached to the print job, since the print job is stored in the print job storage section 52 until the authorized recipient instructs printing, the period of time stored in the print job storage section 52 is relatively long. In other words, as the number of print jobs with authentication request increases, the storage region of the print job storage section 52 becomes occupied.

In the present exemplary embodiment, the following countermeasures are performed.

Countermeasure 1: forcible deletion processing of print jobs with authentication requests for which a predetermined time-limit has elapsed.

Countermeasure 2: prevention of the deletion processing of Countermeasure 1 when the print job sender is different from the recipient.

In the following, print jobs having a different print job sender to recipient may be referred to as “special print jobs”.

Due to Countermeasure 1, effective utilization can be made of the limited storage capacity of the print job storage section 52 by successively deleting old print jobs.

With Countermeasure 2, in consideration that not all old print jobs are print jobs that should be discarded, when predetermined conditions are satisfied (in the present exemplary embodiment, the condition of being a special print job is satisfied), deletion processing based on the Countermeasure 1 is prevented from being performed, whereby the print jobs that may be targets of the Countermeasure 1 can be classified in a greater precision.

In a configuration shown in FIG. 7, functional blocks for performing above Countermeasure 1 and Countermeasure 2 are added.

Namely, a reception date-time management section 56 (a reception section) is connected to the print job reception section 51 shown in FIG. 7. A clock circuit 57 is connected to the reception date-time management section 56, and current date data is continuously input to the reception date-time management section 56. Accordingly, in the clock circuit 57, when a new print job is received by the print job reception section 51, list data for identifying the print job is acquired, and the acquired list data is transmitted together with data of acquired date of the print job (acquired date data) to a list data storage section 58.

The list data is not specifically limited as long it enables identifying a print job, and, for example, may include a serial number, an identification code or the like, and include the authentication data as essential data. The authentication data includes a set of data of authentication necessity, sender identity and recipient identity. Alternately, print jobs which are to be stored in the confidential boxes may be identified at this point in the processing, and such print jobs may be extracted in advance. In this case, only the sender identity and the recipient identity may be essential in the authentication data.

In the list data storage section 58, the list data identifying print jobs and the acquired date data are associated as a pair and stored in a database.

A time-limit monitoring section 59 is connected to the clock circuit 57. The time-limit monitoring section 59 is connected to the list data storage section 58, and monitors the time-limit that has elapsed since the start of storage for each of the print jobs.

In the time-limit monitoring section 59, when it is identified that print job(s) exist for which a predetermined time-limit has elapsed, data of this print job is transmitted to a list data reading section 60. The list data reading section 60 reads out the list data for the print job of expired time-limit, and transmits the list data to a retain or delete determination section 61.

Namely, print jobs corresponding to the list data read by the list data reading section 60 are candidates for deletion.

The retain or delete determination section 61 is connected to a deletion processing section 62, and generally outputs a deletion instruction. Based on the deletion instruction, the deletion processing section 62 identifies corresponding print job(s) in the print job storage section 52, and executes deletion processing thereon.

The retain or delete determination section 61, based on the authentication data in the list data that has been read out, exceptionally prevents output of a deletion instruction for a print job that is determined that authentication is required and the sender and the recipient are different.

Namely, the retain or delete determination section 61, exceptionally excludes special print jobs (print jobs which require authentication and have different sender and recipient), from among the print jobs which require authentication and are stored in the print job storage section 52 for a period until after the predetermined time-limit has been exceeded.

Print Processing Completion Notification Control for Special Print Jobs in the Image Forming Apparatus

Special print jobs are, as described above, print jobs having different sender and recipient. Accordingly, in order for a sender to confirm with certainty whether or not the recipient has received the print job, a separate communication has been required, other than that of the printing system of the present exemplary embodiment, such as inquiring with the recipient, or making an agreement with the recipient in advance for having a predetermined acknowledgement sent from the recipient.

In the image forming apparatuses 30 to 32 in the printing system of the present exemplary embodiment, printing completion notification to the sender is automatically executed for special print jobs. A functional block relating the printing completion notification is shown in FIG. 7.

As shown in FIG. 7, a special print job discrimination section 63 is connected to an output section 55. A completion notification of print processing of a print job is transmitted from the output section 55 to the special print job discrimination section 63. Alternately, the output section 55 may be specialized for transmitting, to the special print job discrimination section 63, notification of completions of print processing for print jobs requiring authentication (i.e., authentication attached print jobs).

The special print job discrimination section 63 is connected to a list data storage section 58.

After a completion notification of print processing for a print job is received from the output section 55 by the special print job discrimination section 63, list data is acquired from the list data storage section 58 for the print job for which print processing is complete, and the print job which the corresponding print processing has been complete is determined whether it is a special print job or not.

The special print job discrimination section 63 is also connected to a sender identification section 64, and, when the determination is made that the print job is a special print job, the sender is identified, and is transmitted to a printing completion notification section 65.

Alternately, a configuration may be made such that special print jobs, which are authentication attached print jobs whose sender and recipient are different, are discernable in the output section 55. In such case, since it is sufficient to acquire only the special print jobs from the output section 55, data from a list data storage section 48 is not required, and the printing completion notification of the special print job may be transmitted directly to the sender identification section 64.

The printing completion notification section 65 notified the identified sender that printing is complete. The notification may, for example, include transmission via the dedicated communications network N for print job transmission and reception, sending an e-mail via the Internet, facsimile transmission using a telephone network, notification to a mobile phone, or the like; however there is no limitation thereto.

Explanation follows regarding the operation of a printing system of the present exemplary embodiment.

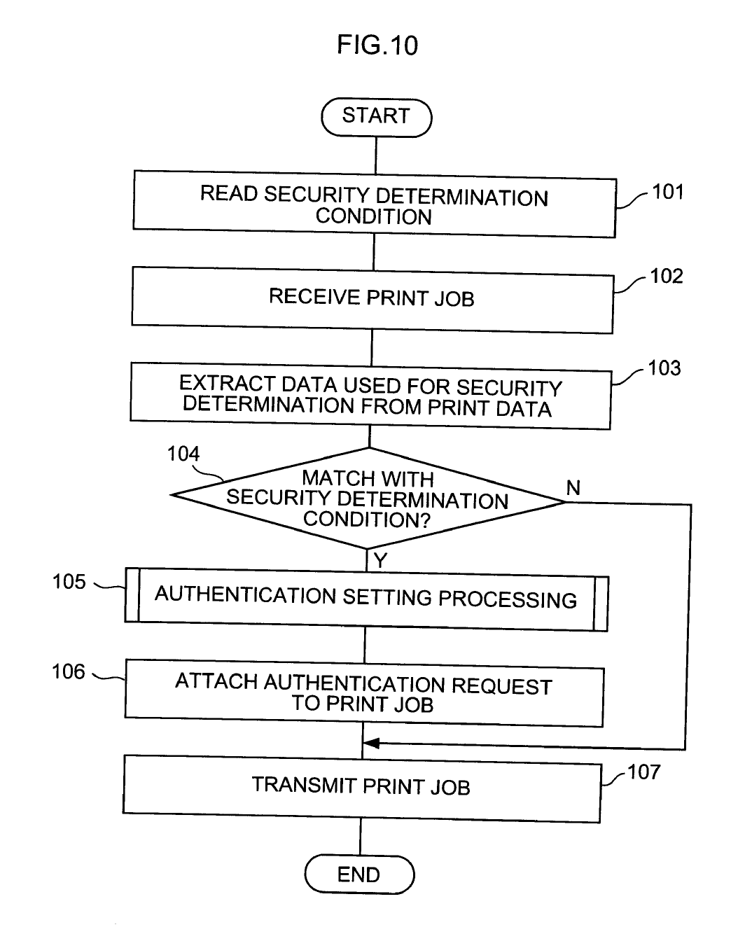

First, the operation of the print server 20, in the printing system of the present exemplary embodiment, will be described with reference to the flow chart of FIG. 10.

In the print server 20, the determination section 45 reads in a security determination condition in advance from the determination condition storage section 42 (step 101).

Then, after the basic data reception section 43 receives a print job from the terminal device 10 (step 102), the data extraction section 44 extracts data used for security determination from the print job (step 103).

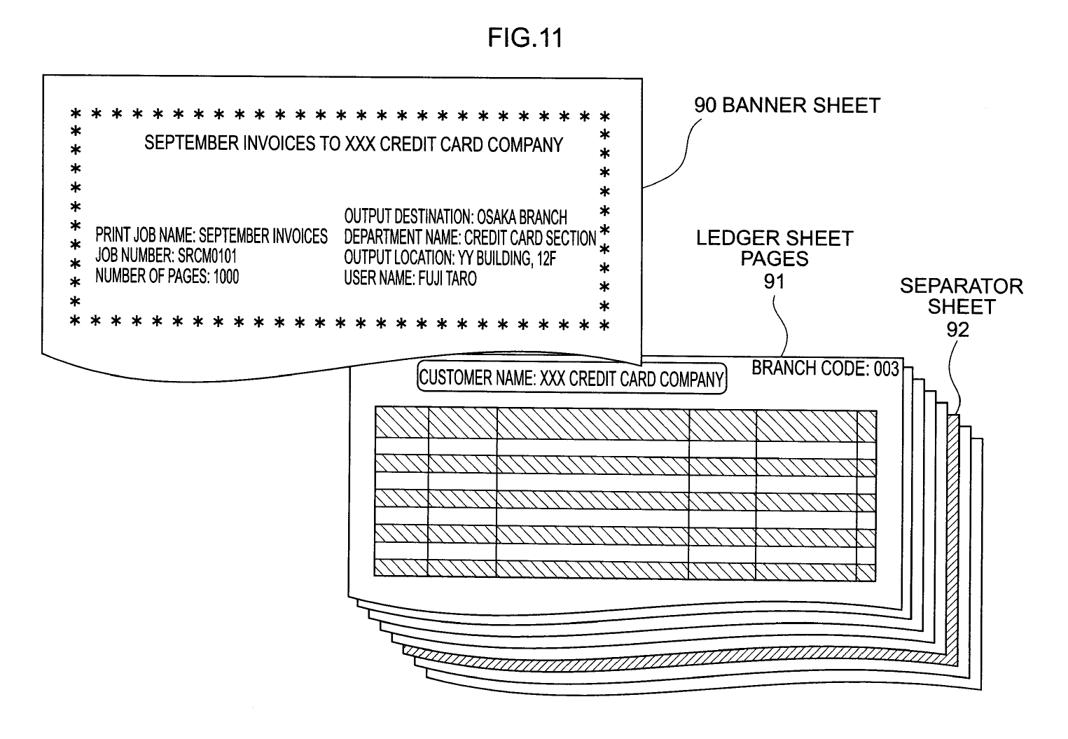

Explanation will be made on a specific example in which print data as shown in FIG. 11 is received. The print data shown in FIG. 11 is configured with a banner sheet 90 at a first page including various data, and successively followed by plural ledger sheet pages 91 which are the pages actually used. There is also a separator sheet 92 provided to separate one set of print data from another set of print data.

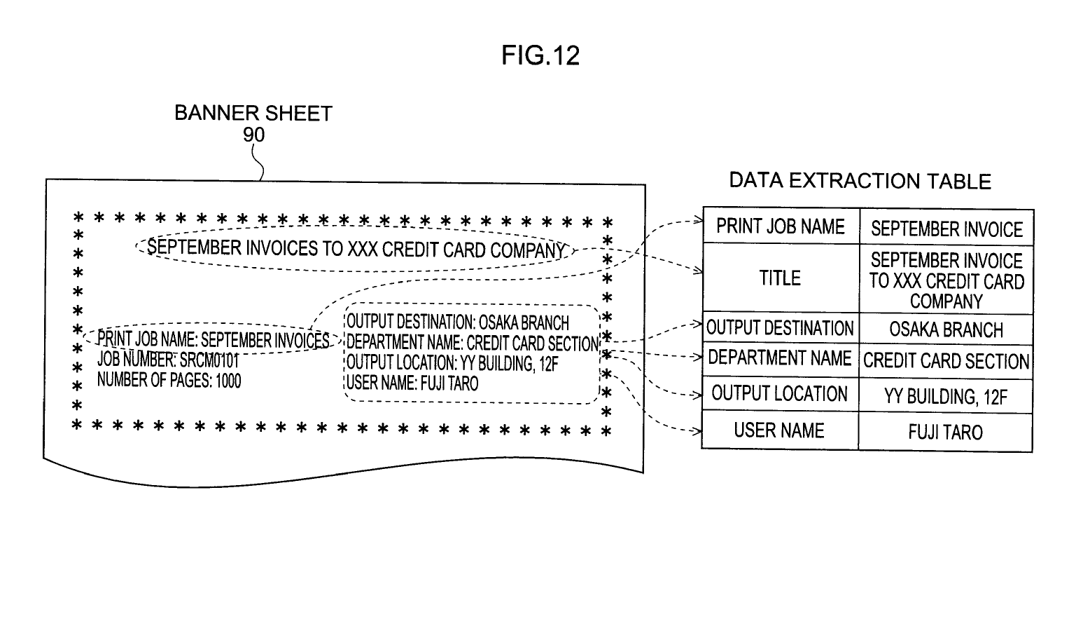

For example, as shown in FIG. 12, when data is extracted from the banner sheet 90, the data extraction section 44, extracts, for example, subject (title), output destination, department name, output location, user name and the like, and generates a data extraction table.

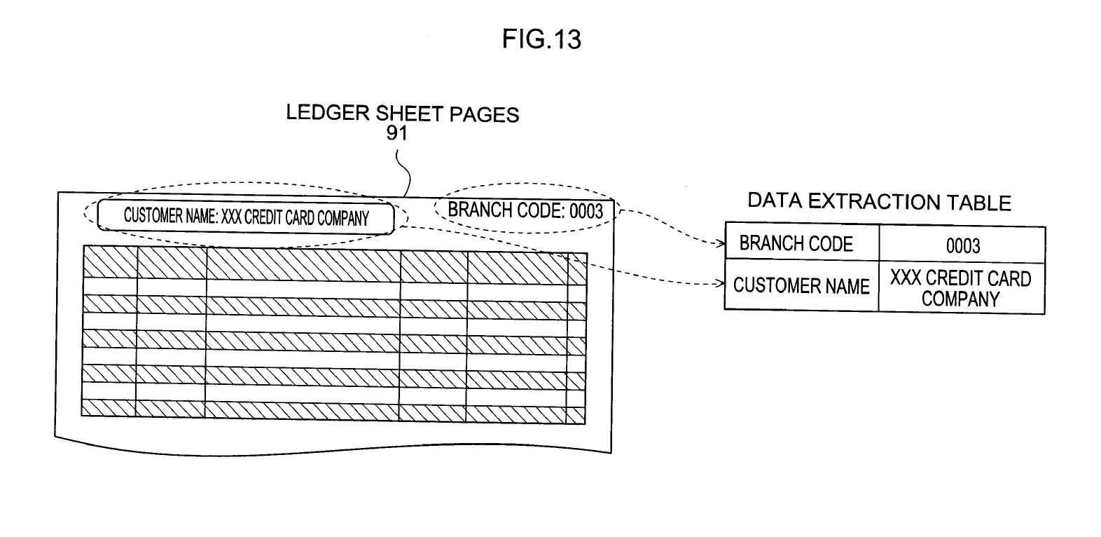

When data is extracted from the ledger sheet pages 91, as shown in FIG. 13, the data extraction section 44 extracts data, such as, for example, the associated branch code, the customer name, and the like, and generates a data extraction table. The data extraction table can be temporarily stored, for example, in the memory 12 or the like.

The determination section 45 determines, based on the data extraction table generated by the data extraction section 44, whether or not the print job for transmission matches the security determination condition read from the determination condition storage section 42 (step 104).

When determination at step 104 is affirmative, various types of authentication setting processing are performed for setting authentication requests for the print job (step 105). Details regarding the authentication setting processing are described later.

The authentication request attaching section 46 attaches the authentication request to the print job (step 106), and transmits the print job attached with the authentication request to any of the image forming apparatuses 30 to 32 (step 107).

At step 104, when a determination is made that the print job for transmission does not match the security determination condition, the print job received by the basic data reception section 43 is transmitted to the image forming apparatuses 30 to 32 by the transmission section 47 without an authentication request being attached thereto.

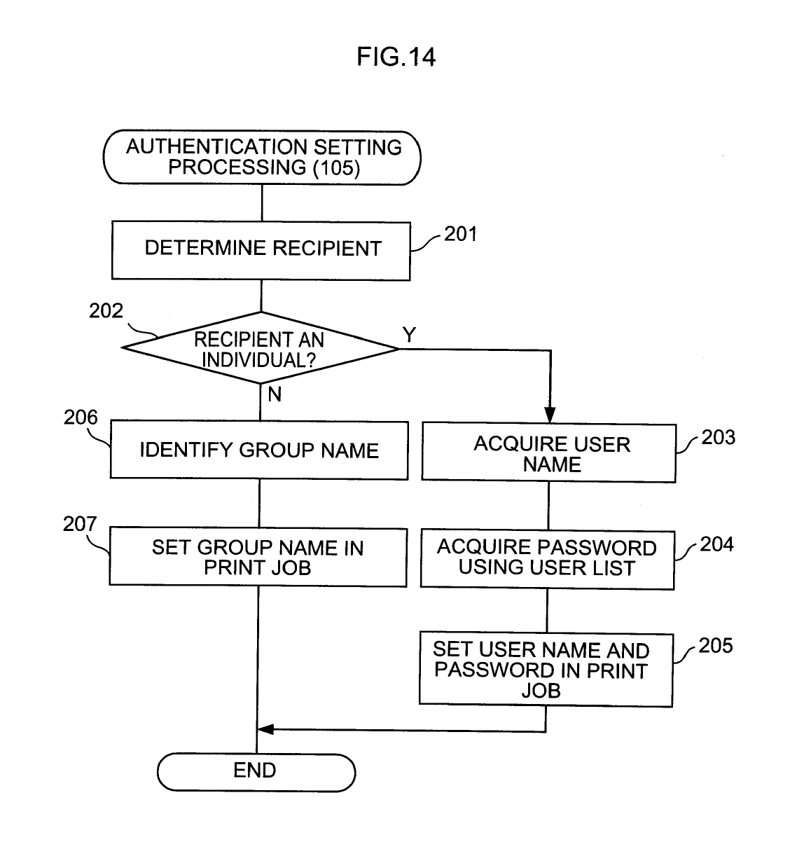

Next, details of the authentication setting processing shown in step 105 of FIG. 10, will be described with reference to the flow chart in FIG. 14.

In the authentication setting processing, the recipient is identified based on a security determination condition table as shown in FIG. 4 (step 201), and when the recipient is an individual (i.e., determination in step 202 is affirmative), password setting is performed (step 203 to step 205).

At step 202, when a determination is made that the recipient is a group rather than an individual (i.e., determination in step 202 is negative), the group name is identified, and the group name is set for the print job (step 206, step 207).

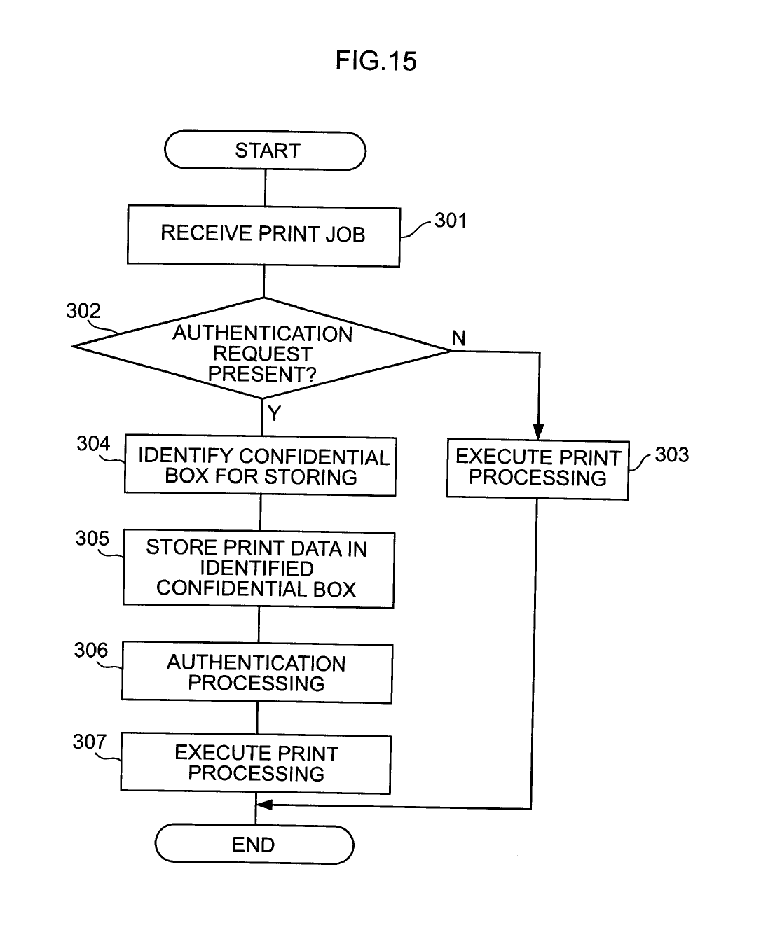

Explanation will be made of the operation when a print job attached with an authentication request is received in the image forming apparatus 30, with reference to the flow chart of FIG. 15. After a print job from the print server 20 is received by the print job reception section 51 and stored in the print job storage section 52 (step 301), the control section 53 determines whether or not this print job is attached with an authentication request (step 302).

In step 302, when a determination is made that the received print job is not attached with an authentication request, normal print processing is executed without authentication request, and in the output section 55, image output processing is performed based on the received print job (step 303).

When a determination is made at step 302 that the received print job is attached with an authentication request, the confidential box in which the print job should be stored is identified (step 304), and the print data is stored in the identified confidential box (step 305).

When a user (recipient) performs image output processing of this print job, authentication request is performed, such as password input request, and when correct authentication processing has been performed (step 306), the output section 55 performs image output processing based on the received print job (step 307).

Flow of Print Job Management Control

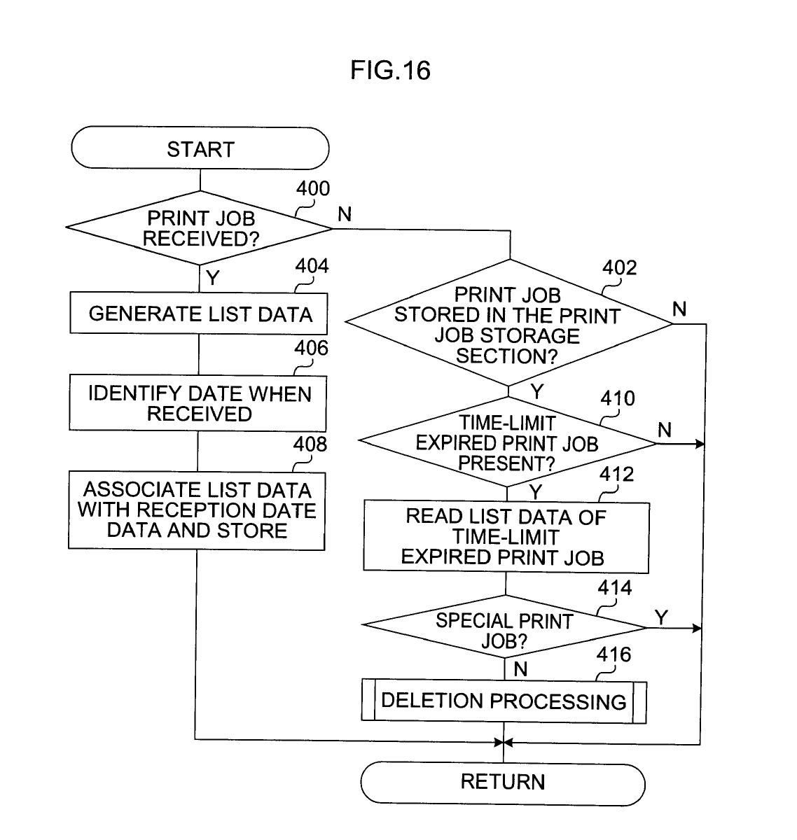

Next, according to the flow chart of FIG. 16, explanation will be given of a flow of print data management control (print job management control), which is performed in response to the processing executed in step 305 (“store print data in identified confidential box”) in the print processing operation (flow chart of FIG. 15) in the image forming apparatuses 30 to 32.

At step 400, determination is made as to whether or not a print job has been received. When this determination is negative, processing proceeds to step 402, and determination is made as to whether or not there is a print job stored in the print job storage section 52. When a negative determination is made at step 402, the current routine is ended.

When an affirmative determination is made at step 400, the control moves to print job registration mode, and the processing proceeds to step 404.

At step 404, list data is generated based on the received print job, next, the processing moves to step 406 where the reception date data is acquired, and then the processing moves to step 408. At step 408, the list data and the reception date data are stored in the list data storage section 58 with association therebetween, and the current routine is ended.

However, when an affirmative determination is made at step 402, the control moves to print job deletion mode control, and the processing proceeds to step 410.

In step 410, determination is made as to whether or not there is a print job whose time-limit has expired among the print jobs stored in the print job storage section 52 (this processing may be performed only to those within one of the confidential boxes). When a negative determination is made, it is determined that there are no print jobs that are candidates for deletion, and the routine ends.

When an affirmative determination is made at step 410, it is determined that there is a job present that is a candidate for deletion, and the processing proceeds to step 412. That is, with this processing, print jobs corresponding to Countermeasure 1 described above have been selected.

In step 412, the list data which the time-limit has been expired is read from the list data storage section 58, the processing next proceeds to step 414, and a determination is made as to whether or not the read print job is a special print job, namely a determination is made as to whether or not the print job is attached with an authentication request and has a different sender and recipient.

In step 414, when a negative determination is made, then it is determined that the identity of the sender and recipient are the same, the processing proceeds to step 416, deletion processing is performed to the authentication attached print job to delete the print job from the print job storage section 52, and the current routine is ended (processing of Countermeasure 1). When an affirmative determination is made at step 414, since a possibility remains that the print job is one remaining unprinted due to a contact to the recipient has not been achieved, the print job is left without being deleted, and the current routine is ended. Accordingly, the Countermeasure 2 is exceptionally executed, and the deletion of special print jobs is avoided.

Flow of Print Processing Completion Notification Control on Special Print Job

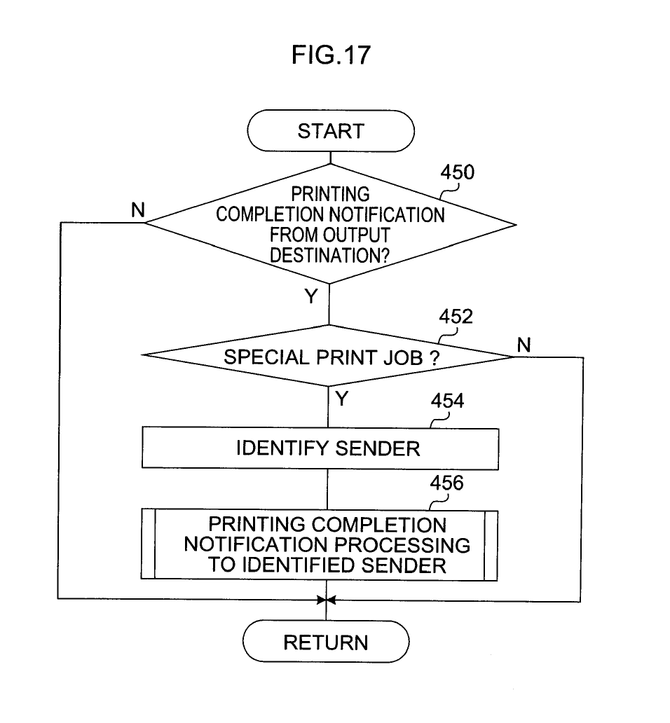

Next, according to the flow chart of FIG. 17, explanation will be given of a flow of printing completion notification of a special print job to a sender, which is performed in response to the processing executed in step 307 (“execute print processing”) in the print processing operation (flow chart of FIG. 15) in the image forming apparatuses 30 to 32.

At step 450, a determination is made in the special print job discrimination section 63 as to whether or not a printing completion notification has been received from the output section 55, and when a negative determination is made, the current routine is ended.

When an affirmative determination is made at step 450, the processing proceeds to step 452, and, based on data from the authentication processing execution section 54 and/or from the list data storage section 58, a determination is made as to whether or not the print job is a special print job. When a negative determination is made at step 452, there is no need to notify the sender of print completion and the current routine is ended.

When an affirmative determination is made at step 452, notification of print completion to the sender is required, the processing proceeds to step 454, and the sender is identified.

At the next step 456, print completion is notified to the identified sender, and the current routine is ended.

Alternately, a configuration may be made such that determination of whether or not the print job is a special print job is made in the output section 55, in which the special print job discrimination section 63 can be omitted. Namely, in this case, all of the print jobs that a printing completion notification is output from the output section 55 being special print jobs, and the print completion may be simply notified to the senders of these special print jobs.

The foregoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiment has been chosen and described in order to best explain the principles of the invention and its practical applications, thereby enabling others skilled in the art to understand the invention for various embodiments and with the various modifications as are suited to the particular use contemplated. The scope of the invention is intended to be defined by the following claims and their equivalents.

What is claimed is:

1. A print job data management device comprising:
a storage section that stores a print job;
a reception section that receives a print job transmitted by a sender;
a print execution section that executes printing immediately when the print job received by the reception section is a first print job without authentication data attached thereto, and, when the print job is a second print job with authentication data attached thereto, temporarily stores the second print job in the storage section and executes printing in response to an authentication of a recipient of a printout; and
an extraction section that extracts the second print job for which a specific duration has elapsed from the storing of the second print job in the storage section,
wherein the print job data management device deletes the print job when the sender and the recipient of the second print job extracted by the extraction section are the same.

2. The print job data management device of claim 1, wherein the print job data management device prevents deletion of the second print job when the sender and the recipient of the second print job extracted by the extraction section are different.

3. A printing apparatus comprising the print job data management device of claim 1,
wherein the printing apparatus receives a print job, from a terminal device or a print server connected to the print job data management device by a communications network, executes print processing, and has an authentication function to authenticate the recipient for the second print job.

4. A method of operating a print job data management device, the method comprising:
receiving a print job transmitted by a sender;
executing printing immediately when the received print job is a first print job without authentication data attached thereto, and, when the print job is a second print job to which authentication data has been attached, temporarily storing the second print job, and executing printing in response to an authentication of a recipient of a printout;
extracting the second print job for which a specific duration has elapsed from the storing; and
deleting the second print job when the sender and the recipient of the extracted second print job are the same.

5. The method of claim 4, further comprising preventing deletion of the second print job when the sender and the recipient of the extracted second print job are different.

6. A storage medium storing a program that causes a computer to execute print job data management processing, the processing comprising:
receiving a print job transmitted by a sender;
executing printing immediately when the received print job is a first print job without authentication data attached thereto, and, when the print job is a second print job to which authentication data has been attached, temporarily storing the second print job, and executing printing in response to an authentication of a recipient of a printout;
extracting the second print job for which a specific duration has elapsed from the storing; and
deleting the second print job when the sender and the recipient of the extracted second print job are the same.

7. The storage medium of claim 6, wherein the processing further comprises preventing deletion of the second print job when the sender and the recipient of the extracted second print job are different.
